(19) United States
(12) Patent Application Publication
(10) Pub. No.: US 2002/0033611 A1
(43) Pub. Date: Mar. 21, 2002

(54) Vacuum handling device

(75) Inventors: Kurt Schmalz, Dornstetten (DE); Thomas Eisele, Fluorn-Winzeln (DE)

Correspondence Address: Dreiss, Fuhlendorf, Steimle & Becker, Postfach 10 37 62, Stuttgart, D-70032, DE

(73) Assignee: J. Schmalz GmbH, Glatten (DE)

(21) Appl. No.: 09/953,179

(22) Filed: Sep. 17, 2001

(30) Foreign Application Priority Data
Sep. 19, 2000 (DE) 100 46 539.0

(51) Int. Cl. A47J 45/00

(52) U.S. Cl. 294/64.1

(57) ABSTRACT

The invention concerns a vacuum handling device comprising a lifting hose (4), which can be connected to a vacuum generating device (12), and a suction gripping device (6) which can be disposed on an object to be handled and with which the object can be suctioned or lifted through retraction of the lifting hose (4), wherein the suction gripping device (6) is provided with a handle (18) for an operator for manipulating the device during proper use, and wherein the suction performance of the vacuum generating device (12) and the associated vacuum prevailing in the lifting hose (4) can be set in a remotely controlled fashion. The handling device is improved by providing an adjustment device (26) to control the rotational speed of the vacuum generating device (12) drive motor (14), the adjustment device (26) being disposed on the suction gripping device (6) for manual operation by the device user during proper use.

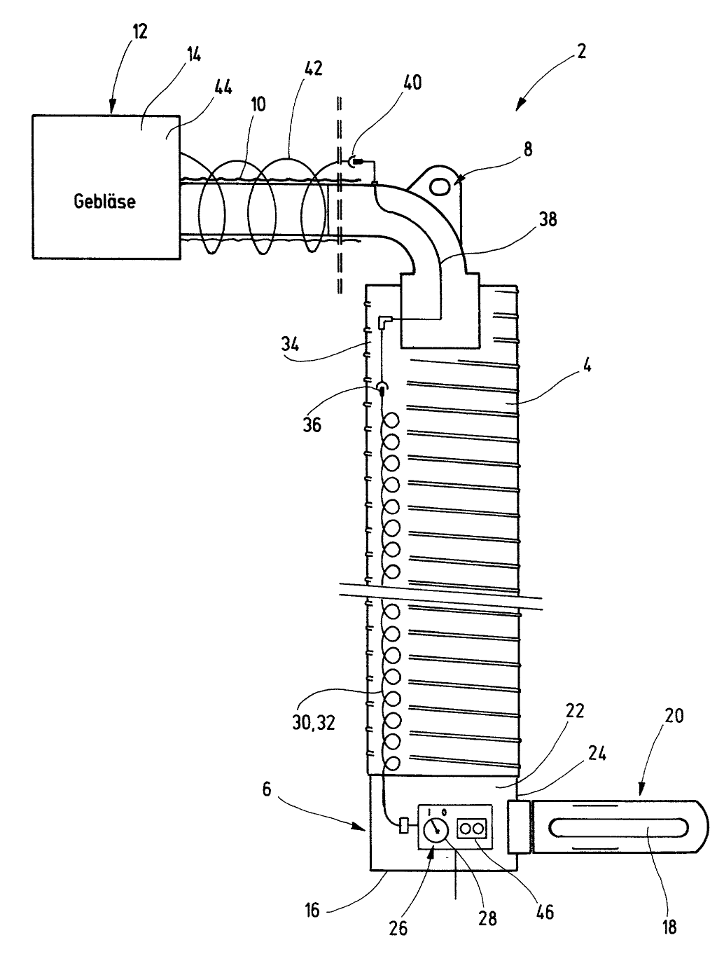

This application claims Paris Convention priority of DE 100 46 539.0 filed Sep. 19, 2000 the complete disclosure of which is hereby incorporated by reference.

### BACKGROUND OF INVENTION

The invention concerns a vacuum handling device with a lifting hose which can be connected to a vacuum generating device, and a suction gripping device which can be disposed onto an object to be handled and with which the object can be suctioned and lifted through retraction of the lifting hose, wherein the suction gripping device is provided with a handle for a user to manipulate the device during proper use, and wherein the suction performance of the vacuum generating device and the associated vacuum prevailing in the lifting hose can be set in a remotely controlled fashion.

A device of this type is disclosed in WO97/36818. This document describes a mechanical remote control of a pump motor.

The adjustment device is not disposed on the vacuum handling device and the mechanical remote control is complicated.

It is therefore the underlying purpose of the present invention to improve the user-friendliness of a vacuum handling device of the mentioned type.

### SUMMARY OF THE INVENTION

This object is achieved in accordance with the invention with a vacuum handling device of this kind in that an adjustment device, which can be manually operated by the user of the device during proper handling, is disposed on the suction gripping device which controls the rotational speed of a drive motor of the vacuum generating device.

In this fashion, the user can operate the adjustment device when using the vacuum handling device in any arbitrary position thereby controlling the vacuum inside the lifting hose for lifting or lowering a suctioned object.

Clearly, the drive motor of the vacuum generating device can be a blower motor or a pump motor for an ejector device operated by pressurized air. In the latter case, the pressurized air volume flow through the ejector device is varied by the rotational speed of the pump motor, thereby varying the suction performance.

In a preferred further development of the invention, the adjustment device is connected to a control electronics of the drive motor via an electrical connection to considerably simplify the adjustment device and its operation. In particular, a potentiometer, preferably a rotary potentiometer which is easy to handle, can be provided.

It is furthermore advantageous, when the adjustment device is disposed on a wall of a base body of the suction gripping device casing which permits definition of and provision for a larger number of manipulations for the same suction gripping device, without having to vary the mountability of the adjustment device. It is, of course, also advantageous to dispose the adjustment device directly on the handle of the suction gripping device, in particular such that it must not necessarily be completely and separately engaged, rather can be conveniently actuated by the user with one hand while gripping the handle.

In a particularly advantageous fashion, the adjustment device is connected to the drive motor of the vacuum generating device via an adjustment connection extending within the lifting hose. In this case, the electrical connection can include electrical plug connection means which are interconnected on site when assembling the vacuum handling device. One arrangement of the electrical connection within the lifting hose is particularly advantageous with which the electrical connection comprises a spirally wound cable which can follow the contraction and extension of the lifting hose.

Clearly, the adjustment device can communicate with the control electronics of the drive motor via radio transmission.

Further features, details and advantages of the invention can be extracted from the claims and the accompanying drawing and the following description of a preferred inventive vacuum handling device.

### BRIEF DESCRIPTION OF THE DRAWING

The FIGURE shows a schematic view of a vacuum handling device comprising an electrical blower.

### DESCRIPTION OF THE PREFERRED EMBODIMENT

The FIGURE shows a vacuum handling device, referred to in its entirety with reference numeral 2, which comprises a lifting hose 1 and a suction gripping device, referred to with reference numeral 6, which are connected to each other. The lifting hose 4 is connected to a vacuum generating device 12 via a rotary transmission device 8 and a vacuum hose section 10, wherein the vacuum generating device is formed by a suction blower 14 driven by an electric motor.

The suction gripping device which comprises conventional suction regions having suction valves and which is not shown in detail, has an operating region 20 provided with at least one handle 18. The overall vacuum handling device is gripped by one user at the handles 18, which project at both sides, and displaced corresponding to requirements, i.e. lowered onto an object to be suctioned or moved with a suctioned object to a remote location to lower the suctioned object etc..

A side wall 22 of a base body 24 of the suction gripping device 6 casing is provided with an adjustment device 26 for controlling the rotational speed of the drive motor 14 and therefore the vacuum within the lifting hose 4. The adjustment device is preferably a rotary potentiometer 28 which the user can easily actuate. The adjustment device 26 is complemented by an electrical connection 30 configured as a spirally wound cable 32 which extends inside the lifting hose 4. An upper end section 34 of the lifting hose 4 is provided with a plug connection means 36 for the cable 32. In this fashion, the cable 32 is coupled to an electrical feed-through 38 within the rotary transmission 8. This section 38 is connected to an electric connecting means 42 within the vacuum generating device 12 with the indicated control electronics 44 of the drive motor 14 via a further plug connection means 14.

The control of the rotational speed of the motor 14 can be activated or deactivated via on/off keys 46 on the adjustment device 26 and the rotational speed can be varied to increase or decrease vacuum within the lifting hose 4 by adjusting the rotary potentiometer 28.

We claim:

1. A vacuum handling device with which a user can manipulate an object, the device comprising:
a vacuum generating device having a control electronics communicating with a drive motor;
a lifting hose having a first end in vacuum communication with said vacuum generating device, said lifting hose also having a second end;
a suction gripping device in vacuum communication with said second end of said lifting hose, said suction gripping device having a handle for the user to manipulate the device during functional use thereof, said suction gripping device also having an adjustment device for manual operation by the user of the vacuum handling device during functional usage thereof; and
means for communication between said adjustment device and said control electronics to remotely control a rotational speed of said drive motor for defining a suction performance of said vacuum generating device and an associated vacuum within said lifting hose, wherein said suction gripping device can be disposed onto the object to suction and lift the object through retraction of said lifting hose.

2. The vacuum handling device of claim 1, wherein said communication means comprises an electrical connection.

3. The vacuum handling device of claim 1, wherein said adjustment device comprises a potentiometer.

4. Vacuum handling device of claim 3, wherein said potentiometer is a rotary potentiometer.

5. The vacuum handling device of claim 1, wherein said suction gripping device further comprises a base body casing having a wall on which said adjustment device is disposed.

6. The vacuum handling device of claim 1, wherein said adjustment device is disposed on said handle of said suction gripping device.

7. The vacuum handling device of claim 1, wherein said communication means comprise a regulating connection extending within said lifting hose to connect said adjustment device to said drive motor.

8. The vacuum handling device of claim 2, wherein said electrical connection comprises electrical plug connection means.

9. The vacuum handling device of claim 8, wherein said plug connection means are disposed within said lifting hose.

10. The vacuum handling device of claim 9, wherein said electric plug connection means are disposed in an upper end section of said lifting hose, wherein said lifting hose further comprises a rotary coupling with which said plug connection means are associated.

11. The vacuum handling device of claim 2, wherein said electrical connection comprises a spirally wound cable.

12. The vacuum handling device of claim 11, wherein said spirally wound cable extends within said lifting hose.

13. The vacuum handling device of claim 1, wherein said communication means comprise radio transmission means to connect said adjustment device to said control electronics of said drive motor.
